(19) United States
(12) Patent Application Publication
(10) Pub. No.: US 2025/0091569 A1
(43) Pub. Date: Mar. 20, 2025

(54) SYSTEMS AND METHODS FOR PARKING A FOLLOWING VEHICLE IN A CONVOY

(71) Applicant: Toyota Motor Engineering & Manufacturing North America, Inc., Plano, TX (US)

(72) Inventors: Shaurya Panthri, Ann Arbor, MI (US); John-Michael McNew, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-Ken (JP)

(21) Appl. No.: 18/469,999

(22) Filed: Sep. 19, 2023

(51) Int. Cl. B60W 30/06; G08G 1/00

(52) U.S. Cl. CPC B60W 30/06; G08G 1/22; B60W 2540/049; B60W 2540/227; B60W 2556/10; B60W 2556/65

(57) ABSTRACT

Systems, methods, and other embodiments described herein relate to parking a following vehicle in a convoy. In one embodiment, a method includes disengaging a virtual connection between a lead vehicle and a following vehicle of a convoy based on a parking trigger for the convoy. The method includes selecting a parking space for the following vehicle based on a load characteristic of the following vehicle and directing the following vehicle to the parking space.

### TECHNICAL FIELD

The subject matter described herein relates, in general, to virtually-connected vehicle convoys and, more particularly, to parking a following vehicle of the vehicle convoy.

### BACKGROUND

In a hitched configuration, a trailer or another wheeled object is physically coupled to a motorized vehicle such that the motorized vehicle pulls the trailer or other wheeled object along and behind the motorized vehicle. Two vehicles may be joined in a hitchless towing or a virtual connection configuration. In a hitchless/virtual towing configuration, a lead vehicle is manually or autonomously controlled, while a following vehicle is at least partially controlled by the lead vehicle. The following vehicle trails the lead vehicle as if physically coupled to the lead vehicle. Platooning or convoying are other configurations in which multiple vehicles maneuver in a coordinated fashion.

However, parking individual vehicles in a platoon, convoy, virtual towing, or hitchless towing configuration is difficult due in part to the coordinated movements of the vehicles within the convoy.

### SUMMARY

In one embodiment, example systems and methods relate to a manner of improving convoy vehicle parking.

In one embodiment, a following vehicle parking system is disclosed. The following vehicle parking system includes one or more processors and a memory communicably coupled to the one or more processors. The memory stores instructions that, when executed by the one or more processors, cause the one or more processors to disengage a virtual connection between a lead vehicle and a following vehicle of a convoy based on a parking trigger for the convoy, select a parking space for the following vehicle based on a load characteristic of the following vehicle, and direct the following vehicle to the parking space.

In one embodiment, a non-transitory computer-readable medium for parking a following vehicle in a convoy and including instructions that, when executed by one or more processors, cause the one or more processors to perform one or more functions is disclosed. The instructions include instructions to disengage a virtual connection between a lead vehicle and a following vehicle of a convoy based on a parking trigger for the convoy, select a parking space for the following vehicle based on a load characteristic of the following vehicle, and direct the following vehicle to the parking space.

In one embodiment, a method for parking a following vehicle in a convoy is disclosed. In one embodiment, the method includes disengaging a virtual connection between a lead vehicle and a following vehicle of a convoy based on a parking trigger for the convoy, selecting a parking space for the following vehicle based on a load characteristic of the following vehicle, and directing the following vehicle to the parking space.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a following vehicle parking system that is associated with parking a following vehicle in a vehicle convoy.

FIG. 3 illustrates a flowchart for one embodiment of a method associated with parking a following vehicle in a convoy.

FIG. 4 illustrates an example of parking a following vehicle in a vehicle convoy.

FIG. 5 illustrates an example of parking a following vehicle in a vehicle convoy.

FIG. 6 illustrates a lead vehicle human-machine interface (HMI) for parking a following vehicle in a vehicle convoy.

### DETAILED DESCRIPTION

Systems, methods, and other embodiments associated with improving vehicle convoy parking are disclosed herein. In a convoy configuration, which may also be referred to as a hitchless towing, a virtual towing, a platooning, or a virtual connection configuration, a lead vehicle is manually or autonomously controlled, while a following vehicle is at least partially controlled by the lead vehicle. That is, the following vehicle may trail the lead vehicle as if physically coupled to the lead vehicle. As such, the following vehicle and the lead vehicle exhibit coordinated movements. However, coordinated movement in the tight confines of a parking structure and/or while performing precision maneuvers such as navigating a vehicle into a parking space may be ill-advised and problematic and, in some cases, may damage the vehicles. For example, a lead vehicle may turn into an open parking space between two occupied spaces. If the following vehicle mimics this movement, the following vehicle may collide with the vehicles in the occupied spaces. As another example, the following vehicle behind the lead vehicle may complicate the repeated motions that the lead vehicle may execute to align itself within the open space. These and other issues may arise as vehicles that share a virtual connection and exhibit coordinated movement attempt to park.

The disclosed systems, methods, and other embodiments improve convoy parking by disengaging the virtual connection between a lead vehicle and a following vehicle prior to or during parking. The disengagement is triggered in various ways, for example, when the lead vehicle parks, enters a parking lot, or is otherwise stationary. As another example, the disengagement is responsive to a lead vehicle driver command received on a human-machine interface (HMI). Once disengaged, the following vehicle can move independently of the lead vehicle. However, the lead vehicle maintains operative control over the following vehicle by authorizing the following vehicle to autonomously park in a selected parking space.

Further, the disclosed systems, methods, and other embodiments intelligently identify, select, and present on a lead vehicle HMI, a recommended parking space for the following vehicle. Specifically, following disengagement, the HMI displays a video feed of the environment encompassing the lead and following vehicles. The video feed presents video data received by the lead and following vehicle cameras such that the driver of the lead vehicle can collectively see the environment of the lead vehicle and the following vehicle.

The system presents candidate parking spaces for the following vehicle based on the following vehicle's physical constraints, such as the following vehicle's size, turning radius, and other features. In an example, the system identifies candidate parking spaces based on the use of the following vehicle, such as whether the following vehicle is a trailer carrying cargo that will be unloaded. Cargo may be detected using sensors (e.g., weight sensors, cameras, etc.) and/or based on manual inputs. As a specific example, if the following vehicle contains cargo to be unloaded through the trunk, the system may suggest and/or control the following vehicle to park in an orientation where the back end of the following vehicle is facing an area that is appropriate for unloading. As another specific example, if the following vehicle contains passengers, the system may suggest and/or control the following vehicle to park in an orientation where the side doors of the vehicle freely open without risk of collision with an adjacent vehicle or another object. As another example, if the following vehicle is towing another object, such as a boat, the system may suggest or control the following vehicle to park in a space that accommodates the boat.

Moreover, the system may suggest parking orientations and spaces based on the machine-learned preferences of the drivers of the vehicles. For example, suppose the driver has historically loaded/unloaded the following vehicle through a particular door of the following vehicle. In that case, the system may park the following vehicle for this use at the recognized location. In any example, when a parking space is selected, the systems, methods, and other embodiments may park the following vehicle in the selected parking space. As such, the present systems, methods, and other embodiments facilitate convoy parking by disengaging the virtual connection responsive to a parking trigger such that the following vehicle may be parked individually and based on the load characteristics of the following vehicle.

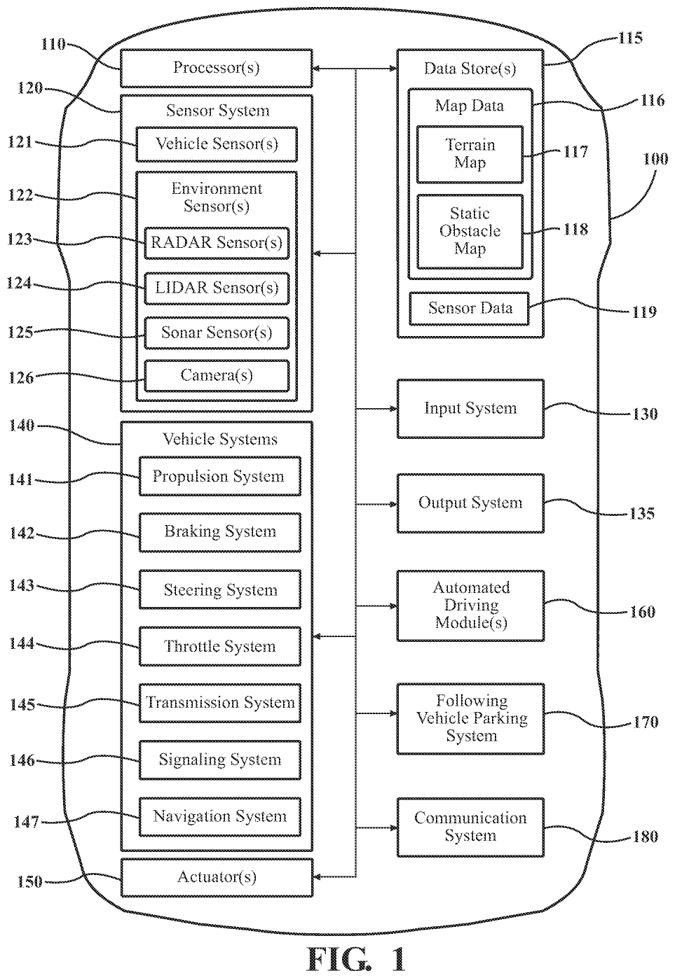

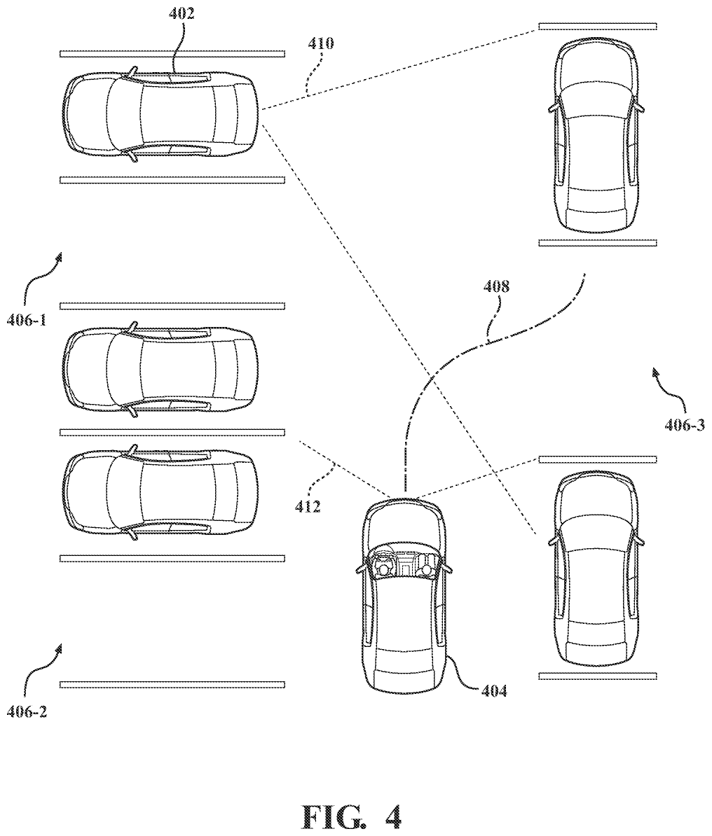

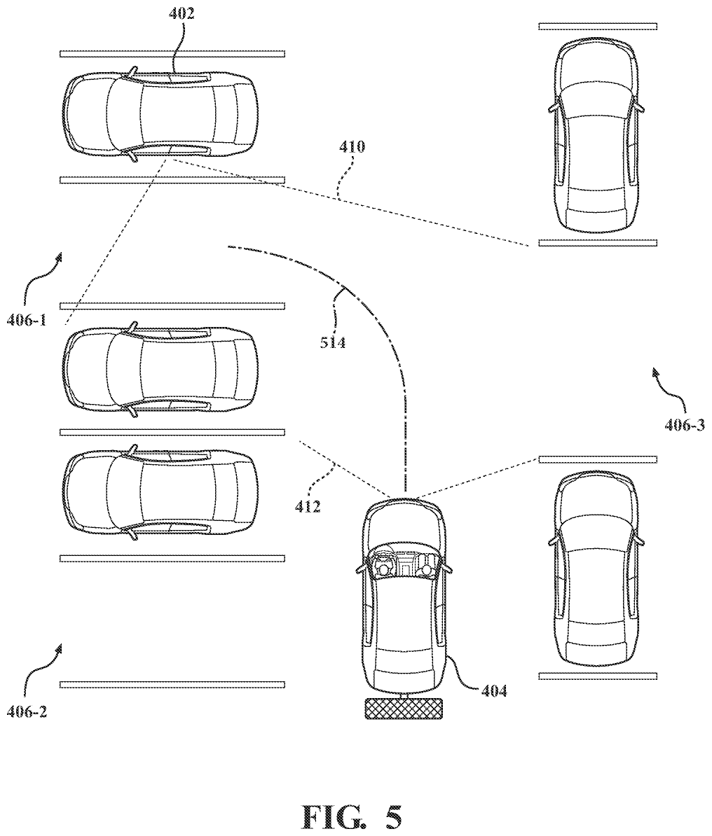

Referring to FIG. 1, an example of a vehicle 100 is illustrated. The vehicle 100 may be a lead vehicle in a convoy as described and depicted in FIGS. 4 and 5 below. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with parking a following vehicle in a vehicle convoy.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

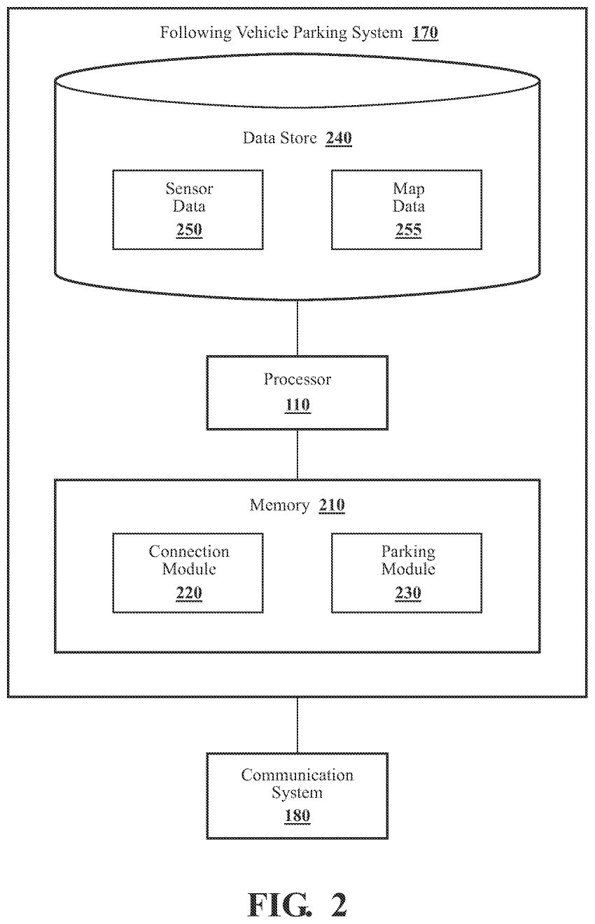

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a following vehicle parking system 170 that is implemented to perform methods and other functions as disclosed herein relating to improving the parking of vehicles in a vehicle convoy.

In an example, the following vehicle parking system 170, in various embodiments, is implemented partially within the vehicle 100, and as a cloud-based service. For example, in one approach, functionality associated with at least one module of the following vehicle parking system 170 is implemented within the vehicle 100 while further functionality is implemented within a cloud-based computing system. Thus, the following vehicle parking system 170 may include a local instance at the vehicle 100 and a remote instance that functions within the cloud-based environment.

Moreover, the following vehicle parking system 170, as provided for within the vehicle 100, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, V2I, V2V, or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the following vehicle parking system 170 can leverage various wireless communication technologies to provide communications to other entities, such as members of the cloud-computing environment.

With reference to FIG. 2, one embodiment of the following vehicle parking system 170 of FIG. 1 is further illustrated. The following vehicle parking system 170 is shown as including a processor 110 from the vehicle 100 of FIG. 1. Accordingly, the processor 110 may be a part of the following vehicle parking system 170, the following vehicle parking system 170 may include a separate processor from the processor 110 of the vehicle 100, or the following vehicle parking system 170 may access the processor 110 through a data bus or another communication path that is separate from the vehicle 100. In one embodiment, the following vehicle parking system 170 includes a memory 210 that stores a connection module 220 and a parking module 230. The memory 210 is a random-access memory (RAM), read-only memory (ROM), a hard-disk drive, a flash memory, or another suitable memory for storing the modules 220 and 230. The modules 220 and 230 are, for example, computer-readable instructions that when executed by the processor 110 cause the processor 110 to perform the various functions disclosed herein. In alternative arrangements, the modules 220 and 230 are independent elements from the memory 210 that are, for example, comprised of hardware elements. Thus, the modules 220 and 230 are alternatively ASICs, hardware-based controllers, a composition of logic gates, or another hardware-based solution.

The following vehicle parking system 170, as illustrated in FIG. 2, is generally an abstracted form of the following vehicle parking system 170. In an example, the following vehicle parking system 170 is embodied at least in part within a cloud-computing environment. In one or more approaches, the cloud environment may facilitate communications between multiple different vehicles to acquire and distribute information between the lead vehicle and following vehicles in a convoy.

In one embodiment, the following vehicle parking system 170 includes the data store 240. The data store 240 is, in one embodiment, an electronic data structure stored in the memory 210 or another data storage device and that is configured with routines that can be executed by the processor 110 for analyzing stored data, providing stored data, organizing stored data, and so on. Thus, in one embodiment, the data store 240 stores data used by the modules 220 and 230 in executing various functions. In one embodiment, the data store 240 stores the sensor data 250 and map data 255 along with, for example, metadata that characterizes various aspects of the sensor data 250 and the map data 255. For example, the metadata can include location coordinates (e.g., longitude and latitude), relative map coordinates or tile identifiers, time/date stamps from when the separate sensor data 250 was generated, and so on.

The sensor data 250 includes data collected from a sensor system 120 of the vehicle 100 (which may be a lead vehicle in a convoy) and data collected from a similar sensor system of a following vehicle of the convoy. This sensor data 250 is used by the connection module 220 to disengage the virtual connection between the lead vehicle and the following vehicle and by the parking module 230 to identify and select a parking space for the following vehicle.

The sensor data 250 includes data from vehicle sensors 121 indicating the vehicle position and/or vehicle movement. Examples of vehicle sensors 121 include accelerometers, gyroscopes, an inertial measurement unit (IMU), a dead-reckoning system, a global navigation satellite system (GNSS), a global positioning system (GPS), and/or other sensors for monitoring aspects of the vehicle 100. The sensor data 250 also includes data from environment sensors 122 of the vehicle. Examples of environment sensors 122 include radar sensors 123, LIDAR sensors 124, sonar sensors 125 (e.g., ultrasonic sensors), and/or cameras 126 (e.g., monocular, stereoscopic, RGB, infrared, etc.). The environment sensor 122 output may have a variety of forms, including images or other output that detects objects, roadway structures, features, and/or landmarks. For example, the sensor data 250 may include environment sensor 122 data that identifies unoccupied parking spaces, potential parking spaces for a lead vehicle or a following vehicle, and other vehicles/objects within a parking structure or parking lot. While particular reference is made to identifying available parking spaces and objects within a parking structure or parking lot, the sensor data 250 may similarly include environment sensor 122 that identifies objects outside a parking structure or a parking lot. For example, the sensor data 250 may include environment sensor 122 data identifying unoccupied parking spaces along a roadway.

In an example, the sensor data 250 may include vehicle sensor 121 data and environment sensor 122 data output from vehicle sensors 121 and environment sensors 122 of both the lead vehicle and the following vehicle. Specifically, the sensor data 250 may include vehicle sensor 121 data and environment sensor 122 data from the lead vehicle and vehicle sensor 121 data and environment sensor 122 data from the following vehicle. The following vehicle parking system 170 of the lead vehicle receives the sensor data from the following vehicle via the communication system 180.

Relying on sensor data 250 from both the lead vehicle and the following vehicle enhances the operation of the following vehicle parking system 170. That is, as depicted in FIGS. 4 and 5, the environment sensors 122 of the different vehicles may have different fields of view. As such, by relying on information collected from multiple environment sensors 122 with different fields of view, a greater overall representation of the convoy environment is provided to the driver of the lead vehicle.

Moreover, were the environment sensors 122 of just the lead vehicle relied on, the following vehicle parking system 170 1) may fail to identify a suitable parking space due to a parking space being outside of the field of view of the lead vehicle sensors or 2) may erroneously classify a particular parking space as suitable due to limitations of image-based object recognition and characterization. That is, the dimensions, shape, and relative position of objects (e.g., parked vehicles, other objects, and open parking spaces) within the convoy environment may be more accurately determined based on multiple sensor outputs, which sensors have different relative positions. That is, relying on different images, in some examples taken from different perspectives, combats the above-described inaccuracy of image-based object recognition and characterization. As such, the lead vehicle sensor system 120 and the following vehicle sensor system 120 cooperatively sense the convoy environment such that the following vehicle parking system 170 may accurately and reliably present parking space recommendations.

The data store 240 also includes map data 255, which includes images or other data that indicates characteristics of the parking space, parking lot, or parking structure. For example, the map data 255 may identify the geographic location (for example via coordinates) of parking lots or parking structures. As with the sensor data 250, the map data 255 may be used by the connection module 220 when disengaging the virtual connection between the lead vehicle and the following vehicle and by the parking module 230 when identifying and selecting a parking space for the following vehicle.

With continued reference to FIG. 2, the connection module 220 generally includes instructions that function to control the processor 110 to, in part, receive data inputs from one or more sensors of the vehicle 100. The inputs are, in one embodiment, observations about the state of the vehicles in the convoy. For example, the data input to the connection module 220 may be from the vehicle sensors 121 that indicate the location and movement of the lead vehicle and the following vehicles. As provided for herein, the connection module 220, in one embodiment, acquires sensor data 250 that includes an accelerometer input, a gyroscope input, an inertial measurement unit (IMU) input, a dead-reckoning input, a GNSS input, a GPS input, and/or other sensor inputs for monitoring aspects the location/movement of the vehicle 100.

Accordingly, the connection module 220, in one embodiment, controls the respective sensors to provide the data inputs in the form of the sensor data 250. Additionally, while the connection module 220 is discussed as controlling the various sensors to provide the sensor data 250, in one or more embodiments, the connection module 220 can employ other techniques to acquire the sensor data 250 that are either active or passive. For example, the connection module 220 may passively sniff the sensor data 250 from a stream of electronic information provided by the various sensors to further components within the vehicle 100. Moreover, the connection module 220 can undertake various approaches to fuse data from multiple sensors when providing the sensor data 250 and/or from sensor data acquired over a wireless communication link (e.g., v2v) from one or more of the surrounding vehicles. Thus, the sensor data 250, in one embodiment, represents a combination of perceptions acquired from multiple sensors.

Additionally, the connection module 220, in one embodiment, includes instructions that cause the processor 110 to disengage a virtual connection between a lead vehicle and a following vehicle of a convoy based on a parking trigger for the convoy. As described above, the coordinated movement of vehicles in a convoy may complicate the parking of the vehicles in the convoy, both the lead vehicle and any following vehicles. As such, the connection module 220, based on a detected parking trigger, disengages the virtual connection such that the vehicles in the convoy move independently and can, therefore, navigate to a parking space without being troubled by the coordinated movement of another vehicle.

Note that disengagement of the virtual connection removes the coordinated movement relationship between the lead vehicle and the following vehicle such that the following vehicle no longer mimics the movements of the lead vehicle nor trails the lead vehicle as if physically connected. Even when the virtual connection is disengaged, the lead vehicle may retain control over the following vehicle by transmitting a command to the following vehicle, which includes an instruction to park in a parking space. In an example, disengagement of the virtual connection includes reconfiguring any number of the vehicle 100 components depicted in FIG. 1, such that instructions that direct the following vehicle to trail the lead vehicle are not generated or are not transmitted to the following vehicle. For example, disengagement of the virtual connection may include reconfiguring the communication system 180 such that lead vehicle-following commands are interrupted or blocked from transmission to the following vehicle. Following disengagement, the following vehicle may move independently of the lead vehicle and may remain motionless until a command is received from the lead vehicle to park.

Various conditions may trigger the virtual connection disengagement. In general, the parking trigger for connection disengagement is based on vehicle location and/or vehicle movement relative to a region where a vehicle is to be parked (e.g., a parking space, a parking lot, or a parking structure). As such, the connection module 220 may include one or more devices, applications, and/or combinations thereof to determine, based on the sensor data 250 and the map data 255, the geographic location of the vehicle 100 relative to the parking space, parking lot, parking structure, or other location where the convoy is to park. In an example, the connection module 220 may include or at least provide a connection to a global positioning system, a local positioning system, or a geolocation system.

In one example, the parking trigger is an indication that the vehicle 100, which may be a lead vehicle in a convoy, is stationary and in the vicinity of a parking location (e.g., parking space, parking lot, parking structure, or other location where the convoy is to park). For example, as a convoy approaches or enters a parking lot, the convoy may stop. In this example, the connection module 220 relies on sensor data 250 and map data 255 to identify when the convoy is near a parking location. Based on 1) the location of the vehicle 100 being in the vicinity of the parking location (as determined by the sensor data 250 and the map data 255) and 2) the sensor data 250 indicating that the vehicle 100 is moving slowly or stopped, the connection module 220 may disengage the virtual connection such that the following vehicle may move independently of the lead vehicle. Following disengagement, a driver may navigate the vehicle 100, which may be a lead vehicle of a convoy, to a parking space. In contrast, the following vehicle may remain stationary until directed by the driver of the lead vehicle to navigate toward a parking space.

In one example, the parking trigger is an indication that the vehicle 100 is in a parking space or a parking lot. Again, in this example, the connection module 220 relies on sensor data 250 and map data 255 to identify when the vehicle 100, which may be a lead vehicle, is in a parking space or a parking lot. As an example, the sensor data 250 may indicate the presence of vehicles on adjacent sides of the vehicle 100 and/or parking stall lines on either side of the vehicle. From this information, the connection module 220 may identify the vehicle 100 as being in a parking space. Based on the location of the vehicle 100 being motionless within the parking space, parking lot, or parking structure (as determined by the sensor data 250 and map data 255), the connection module 220 may disengage the virtual connection as described above such that the following vehicle may move independently of the lead vehicle.

In any of these examples, the sensor data 250 and the map data 255 may be coordinate-location based. That is, the sensor data 250 may indicate vehicle 100 location via coordinates, and the map data 255 may indicate the locations of parking spaces, parking lots, parking structures, and nearby objects via coordinates. In this example, the processor 110 compares the coordinate data of the vehicle 100 (as indicated in the sensor data 250) to coordinate data for the parking spaces, parking lots, and parking structures (as indicated in the map data 255) to determine when the vehicle 100 is within a threshold distance from the parking space, parking lot, or parking structure.

In another example, the sensor data 250 and the map data 255 may be vision-based. For example, the sensor data 250 may include images or other sensor outputs representing the environment of the vehicle 100. The map data 255 similarly includes images or other data, which indicates characteristics of the parking space, parking lot, or parking structure. In this example, the processor 110 compares data from the environment sensors 122 of the vehicle 100 to environmental data in the map data 255 to determine when the vehicle location is within a threshold distance from the parking space, parking lot, or parking structure or positioned in a parking space, parking lot, or parking structure. While particular reference is made to specific methods of identifying the location of the vehicle 100, other mechanisms or combinations of mechanisms, including those described above, may be used to determine the location of the vehicle 100.

As such, the connection module 220, in one embodiment, includes instructions that cause the processor 110 to retrieve sensor data 250 and map data 255 to 1) identify a parking trigger for a vehicle convoy and 2) disengage a virtual connection between a lead vehicle and a following vehicle of a convoy based on the parking trigger for the convoy.

The following vehicle parking system 170 further includes a parking module 230, which also generally includes instructions that function to control the processor 110 to receive data inputs from one or more sensors of the vehicle 100. The inputs passed to the parking module 230 are, in one embodiment, observations of one or more objects in an environment proximate to the vehicle 100 and/or other aspects of the surroundings. As provided herein, the parking module 230, in one embodiment, acquires sensor data 250, including at least camera images that identify available parking spaces and nearby objects such as vehicles. In further arrangements, the parking module 230 acquires the sensor data 250 from further sensors such as a radar sensor 123, a LiDAR sensor 124, and other sensors as may be suitable for identifying vehicles and locations of the vehicles.

Accordingly, the parking module 230, in one embodiment, controls the respective sensors to provide the data inputs in the form of the sensor data 250. Additionally, while the parking module 230 is discussed as controlling the various sensors to provide the sensor data 250, in one or more embodiments, the parking module 230 can employ other techniques to acquire the sensor data 250 that are either active or passive. For example, the parking module 230 may passively sniff the sensor data 250 from a stream of electronic information provided by the various sensors to further components within the vehicle 100. Moreover, the parking module 230 can undertake various approaches to fuse data from multiple sensors when providing the sensor data 250 and/or from sensor data acquired over a wireless communication link (e.g., v2v) from one or more of the surrounding vehicles. Thus, the sensor data 250, in one embodiment, represents a combination of perceptions acquired from multiple sensors.

The sensor data 250 may include, for example, information about available parking spaces, the characteristics of the parking spaces (e.g., size, dimensions, etc.), and so on. Moreover, in one embodiment, the parking module 230 controls the sensors to acquire the sensor data 250 about an area that encompasses 360 degrees about the vehicle 100 to provide a comprehensive assessment of the surrounding environment. Of course, in alternative embodiments, the parking module 230 may acquire the sensor data about a forward direction alone when, for example, the vehicle 100 is not equipped with further sensors to include additional regions about the vehicle and/or the additional regions are not scanned due to other reasons (e.g., unnecessary due to known current conditions).

In addition to acquiring environment sensor data 250, the parking module 230, in one embodiment, includes instructions that cause the processor 110 to select a parking space for the following vehicle. That is, not all available parking spaces are suitable for the following vehicle. Some parking spaces may be smaller than the following vehicle or may not facilitate the unloading of cargo or passengers from the following vehicle. For example, the trunk of a following vehicle may be loaded with cargo. As such, a parking space that does not provide clearance behind the trunk (e.g., a parallel parking space) may not be suitable for the following vehicle. As such, the parking module 230 identifies suitable parking spaces for the following vehicle based on characteristics, such as a load characteristic of the following vehicle. Specifically, the parking module 230, relying on environment sensor data 250 from both the lead vehicle and the following vehicle, may detect available parking spaces (i.e., those parking spaces that do not have a vehicle already parked therein), which spaces may be along the side of a road or within a parking lot or a parking structure.

Identification of parking spaces may include image analysis of the environment sensor 122 output. For example, from an image captured by a camera 126 of the vehicle 100, the processor 110 may perform image analysis to identify gaps between adjacent vehicles or objects, parking space markers, or other environmental cues that indicate a parking space. While particular reference is made to particular methods for identifying parking spaces, the system may rely on any number of mechanisms to identify available parking spaces and other objects within a target parking location.

The parking module 230 then identifies those parking spaces that are suitable parking spaces for the following vehicle. In an example, a suitable parking space is identified based on a load characteristic of the vehicle 100. A load characteristic refers to a type of the load of the vehicle and a region of the vehicle 100 where the load is to be removed or unloaded. As used in the present specification, the term “load” includes cargo and passengers.

In an example, the parking space that is identified and selected for the following vehicle is based on a clearance (i.e., unobstructed space) adjacent to the region of the vehicle 100 where the load will be removed. The clearance represents the gap between the vehicle 100 and another object, such as an adjacent vehicle or an object. As such, the parking module 230 may select a parking space with the most clearance adjacent to a load-removing region of the vehicle 100 compared to other available parking spaces. The parking module 230 may identify the clearance based on collected sensor data 250. That is, the parking module 230 may, via image analysis, determine the dimensions of an unoccupied parking space and the dimensions of an unoccupied region that is adjacent to the unoccupied parking space and may recommend a parking space with the most clearance or recommend multiple parking spaces that each has sufficient clearance based on a predetermined threshold.

As a specific example, passengers may be seated in the following vehicle. In this example, the load characteristic may indicate the position of the passengers within the vehicle. As such, the parking module 230 identifies and selects a parking space that would provide the most clearance adjacent to the side doors of the vehicle 100 through which the passengers are to exit the vehicle.

In another example, the following vehicle may include cargo to be unloaded from the trunk of the following vehicle. In this example, the load characteristic may indicate a door (e.g., the trunk) through which the cargo will be unloaded. As such, the parking module 230 selects a parking space with the most clearance adjacent to the trunk of the following vehicle.

In some examples, the parking module 230 may deem a parking space unsuitable if the clearance is less than a threshold amount. For example, suppose the clearance of a parking space would not allow a side door of the following vehicle from opening enough for a passenger to exit. In that case, the parking space may be deemed unsuitable and not presented to the lead vehicle driver as an option. In some examples, the threshold amount may be based on sensor input, such as door swing sensor information indicating a pattern of door swing amounts. In other examples, the threshold amount may be set based on user preference and/or vehicle data stored in the data store 240.

The parking module 230 can include one or more devices, applications, and/or combinations thereof to determine the load characteristic of the following vehicle. Such devices and applications may include in-cabin sensors such as weight sensors, cameras, or other sensors to identify the presence, location, and characteristics of loads (which include people and objects) of the vehicle 100. The sensors may also be external sensors such as weight sensors, cameras, or other sensors to determine the external loads of the vehicle. For example, some vehicles 100 include hitches where racks, such as cargo racks, may be attached. In this example, the parking module 230 considers whether or not such a rack is installed in selecting a parking space, for example, by selecting a perpendicular parking space with the largest rear clearance for unloading the cargo rack. As another example, an external sensor may indicate a rooftop storage rack. In this example, the parking module 230 may select a parking space with sufficient lateral clearance to allow a user to unload the rooftop storage rack from a side of the vehicle. As such, the parking module 230 may rely on any number of vehicle sensors to determine the load characteristics of the vehicle. In an example, a user may manually input the load characteristic, for example via an HMI.

In an example, the parking module 230 may rely on vehicle characteristics stored in the data store 240 in selecting a parking space for the following vehicle. For example, a vehicle may have certain characteristics, such as geometric dimensions and operational characteristics. In this example, the parking module 230 may identify suitable parking spaces that comply with the characteristics. In a specific example, a parking space for which the trajectory has a turn radius smaller than a minimum turn radius for the following vehicle would not be indicated as a suitable parking space for the following vehicle.

While particular reference is made to deeming a particular parking space unsuitable based on a conflict between the vehicle and parking space characteristics, in an example, a non-conforming parking space may be de-emphasized. That is, rather than a binary decision regarding a non-conforming parking space, the parking module 230 may weigh the non-conformance of a particular parking space when making a recommendation. In other words, the parking module 230 may weigh the recommendation of a parking space based on a degree of non-conformance of the parking space with the vehicle characteristics.

As such, the parking module 230 receives a variety of environment sensor data 250 as well as characteristics of the following vehicle, including its load characteristics, and selects a parking space for the following vehicle based on the load characteristic, environment sensor data 250, and other characteristics of the following vehicle and parking space.

In an example, the parking module 230 selects a parking space for the following vehicle based on a machine-learning analysis of a user history of unloading. For example, it may be determined that when unloading passengers, a certain user historically prefers a parallel parking space where the side doors of the vehicle are unobstructed rather than a perpendicular parking space where side doors may be blocked by vehicles in adjacent parking spaces. As such, the parking module 230 implements and/or otherwise uses a machine learning algorithm to identify patterns in user behavior and selects parking spaces for the following vehicle based on such patterns. Implementing a machine learning algorithm includes adjusting one or more of the weights, variables, and other features of the algorithm based on the behaviors and patterns of the user regarding the unloading and/or loading of the vehicle. As such, the input to the machine learning parking module 230 includes the sensor data 250, the map data 255, and a log of past user behaviors. The output is a recommended parking space for the following vehicle.

In any case, in addition to selecting a parking space for the following vehicle, the parking module 230, in one embodiment, includes instructions that cause the processor 110 to direct the following vehicle to the parking space. In one example, this may include autonomously guiding the following vehicle to an identified parking space. In an example, such direction may be under the management/supervision of the lead vehicle or a driver of the lead vehicle. That is, as described above, even though coordinated movement between the lead vehicle and the following vehicle is disengaged, the lead vehicle may continue to control the operation of the following vehicle. In this example, a selected parking space, or set of selected parking spaces, may be presented on an HMI of the lead vehicle. For example, the selected parking spaces may be digitally overlaid on an image of the parking structure as captured by environment sensors 122 of the lead vehicle and the following vehicle. The driver of the lead vehicle may then select a parking space for the following vehicle, after which the following vehicle may be autonomously guided to park in the parking space. During autonomous parking guidance, the lead driver may intervene to supersede the autonomous parking. For example, should an object cross the trajectory of the following vehicle, the lead vehicle driver may, via the HMI, abort the parking process to avoid a collision.

In one approach, the connection module 220 and/or the parking module 230 implement and/or otherwise use a machine learning algorithm. In one configuration, the machine learning algorithm is embedded within the connection module 220 and/or parking module 230 for example as a convolutional neural network (CNN), to perform connection disengagement and parking space identification. Of course, in further aspects, the connection module 220 and/or parking module 230 may employ different machine learning algorithms or implement different approaches for performing the connection disengagement and parking space identification. Whichever particular approach the connection module 220 and/or parking module 230 implement, the connection module 220 and/or parking module 230 disengage convoy virtual connections and provide an output that identifies suitable parking spaces for the following vehicle. In this way, the following vehicle parking system 170 facilitates safe parking of a following vehicle of a convoy.

As such, in one or more configurations, the following vehicle parking system 170 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the following vehicle parking system 170 or another system generally trains the machine learning algorithm according to a particular training approach, which may include supervised training, self-supervised training, reinforcement learning, and so on. In contrast to training/learning of the machine learning algorithm, the following vehicle parking system 170 implements the machine learning algorithm to perform inference. Thus, the general use of the machine learning algorithm is described as inference.

Moreover, the following vehicle parking system 170, as provided for within the vehicle 100, functions in cooperation with a communication system 180. Via the communication system 180, the following vehicle parking system 170 receives sensor data 250 from the sensor system 120 of the vehicle 100 and a following vehicle in accordance with the principles described herein. Moreover, via the communication system 180, the parking module 230 passes control signals to the following vehicle in accordance with the principles described herein.

In an example, the communication system 180 includes a physical bus or busses to transmit information between connected components. In an example, the communication system 180 is a wireless system communicating with associated components according to one or more wireless communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, or another suitable protocol for communicating between the following vehicle parking system 170 and other entities in the vehicle 100. In any case, the following vehicle parking system 170 can leverage various wireless communication technologies to provide communications to other components of the vehicle 100.

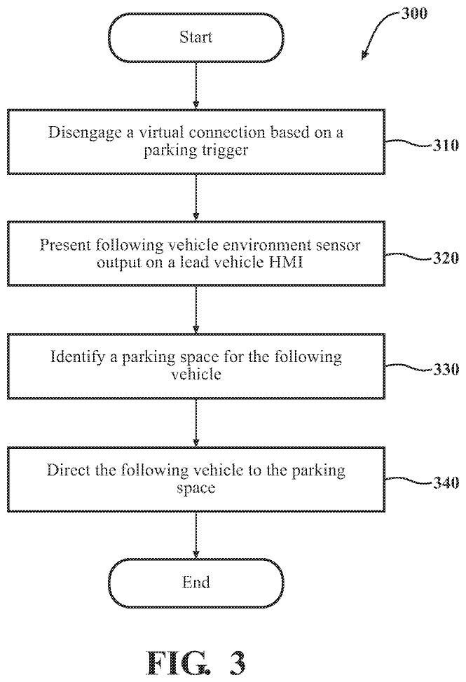

Additional aspects of following vehicle parking will be discussed in relation to FIG. 3. FIG. 3 illustrates a flowchart of a method 300 that is associated with parking a following vehicle in a convoy. Method 300 will be discussed from the perspective of the following vehicle parking system 170 of FIGS. 1 and 2. While method 300 is discussed in combination with the following vehicle parking system 170, it should be appreciated that the method 300 is not limited to being implemented within the following vehicle parking system 170 but is instead one example of a system that may implement the method 300.

At 310, the connection module 220 disengages the virtual connection between a lead vehicle and a following vehicle of a convoy based on a parking trigger for the convoy. As described above, such disengagement is based on sensor data 250 collected from the lead vehicle. As such, the connection module 220 controls the sensor system 120 to acquire the sensor data 250. In one embodiment, the connection module 220 controls the vehicle sensors 121 and the environment sensors 122 to observe the vehicle state and the surrounding environment. Alternatively, or additionally, the connection module 220 controls the camera 126 and the LiDAR sensor 124 or another set of sensors to acquire the sensor data 250. As part of controlling the sensors to acquire the sensor data 250, it is generally understood that the sensors acquire the sensor data 250 of a region around the vehicle 100 with data acquired from different types of sensors generally overlapping in order to provide for a comprehensive sampling of the surrounding environment at each time step. In general, the sensor data 250 need not be of the exact same bounded region in the surrounding environment but should include a sufficient area of overlap such that distinct aspects of the area can be correlated. Thus, the connection module 220, in one embodiment, controls the sensors to acquire the sensor data 250 of the surrounding environment.

Moreover, in further embodiments, the connection module 220 controls the sensors to acquire the sensor data 250 at successive iterations or time steps. Additionally, as previously noted, the connection module 220, when acquiring data from multiple sensors, fuses the data together to form the sensor data 250 and to provide for improved determinations of detection, location, and so on.

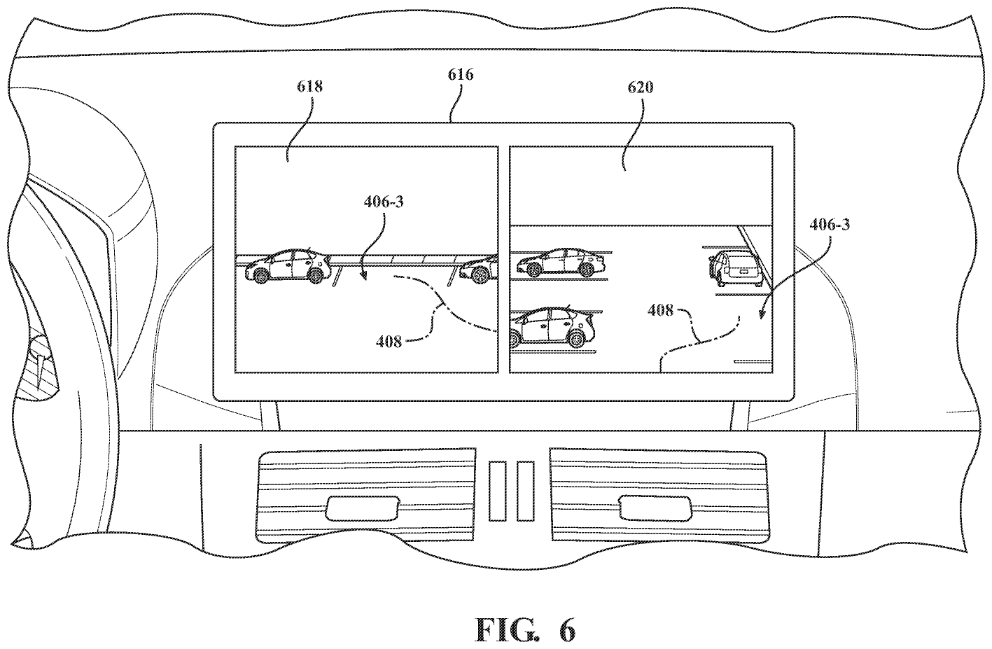

At 320, the following vehicle parking system 170, upon disengagement of the virtual connection, causes the processor 110 to present the following vehicle environment sensor output on an HMI of the lead vehicle. The HMI may be any display device, such as an infotainment center of the lead vehicle. Through the HMI display, the driver of the lead vehicle may be able to observe the autonomous parking of the following vehicle and intervene as needed. Also, through the HMI, the driver of the lead vehicle may be able to select a parking space for the following vehicle and/or authorize autonomous parking of the following vehicle. As described below in connection with FIG. 6, the environment sensor 122 data from the following vehicle may be displayed adjacent to the environment sensor 122 data from the lead vehicle. In other examples, the environment sensor 122 data of the following vehicle may be stitched or merged with the environment sensor 122 data of the lead vehicle to form a single image on the HMI. In either case, presenting an in-cabin representation of the convoy environment based on environment sensor 122 data from both the lead vehicle and the following vehicle provides a broader field of view and/or a more accurate representation of the convoy environment.

At 330, the parking module 230 identifies a target parking space for the following vehicle. That is, as described above, the parking module 230, relying on sensor data 250 from both the lead vehicle and the following vehicle, map data 255, and a load characteristic of the following vehicle, recommends a particular parking space for the following vehicle. As described above, the parking space selection is based on sensor data 250 collected from both the lead vehicle and the following vehicle. As such, the parking module 230 controls the sensor system 120 to acquire the sensor data 250 and the communication system 180 to receive sensor data 250 from the following vehicle. In one embodiment, the parking module 230 controls the vehicle sensors 121 and the environment sensors 122 to observe the surrounding environment. Alternatively, or additionally, the parking module 230 controls the camera 126 and the LiDAR sensor 124 or another set of sensors to acquire the sensor data 250.

Moreover, in further embodiments, the parking module 230 controls the sensors to acquire the sensor data 250 at successive iterations or time steps. Additionally, as previously noted, the parking module 230, when acquiring data from multiple sensors, fuses the data together to form the sensor data 250 and to provide for improved determinations of detection, location, and so on.

In an example, the recommended parking space is selected based on the following vehicle sensor data and lead vehicle sensor data that cooperatively indicate a characteristic of the parking space. As described above, relying on the sensor data 250 of two vehicles may provide a wider field of view of the parking region and/or more accurate information regarding the size, dimensions, and other characteristics of objects detected within the surroundings of the convoy. For example, geometric measurements from the environment sensors of a single vehicle may be distorted or otherwise inaccurate. As such, relying on sensor data 250 from two vehicles, the following vehicle parking system 170 provides a more accurate and reliable recommendation where the relative size and dimensions of the parking space and other objects in the vicinity of the convoy are more accurately represented.

As described above, identification of the target parking space is based, at least in part, on the load characteristic of the following vehicle, which load characteristic is determined via manual input from a user, based on database information, and/or the sensor system 120 of the following vehicle. For example, the sensor system 120 may include in-cabin cameras that identify the quantity and location of passengers in the following vehicle. In this example, the load characteristic may include the number of passengers and the doors through which the passengers are likely to exit.

In an example, identification of the parking space also includes an orientation of the following vehicle within the parking space. For example, a parking space may be such that one end of the following vehicle has clearance for unloading/loading while the other end of the following vehicle is adjacent to another vehicle. In the case of a rear-loaded vehicle, the recommendation may indicate that the following vehicle is to enter the parking space to provide clearance to the rear end of the following vehicle.

In an example, the parking module 230 identifies a parking space based on machine-learning analysis of historical user behavior. Specifically, the history of how a user unloads cargo or of how users exit a vehicle are considered when selecting a particular parking space for the following vehicle.

At 340, the parking module 230 directs the following vehicle to the parking space. As described above, such direction may follow lead driver selection and authorization. In any case, the selected or recommended parking space is presented on the HMI of the lead vehicle for a passenger of the lead vehicle to select or authorize. That is, the parking module 230 may, based on the sensor data 250, present a virtual indication of the recommended parking space on the HMI of the lead vehicle. Through the HMI, a passenger of the lead vehicle triggers a command that directs the following vehicle to proceed to the parking space. Upon authorization from the lead driver, the following vehicle parking system 170 transmits a command to the following vehicle to park in the identified parking space.

FIG. 4 illustrates an example of parking a following vehicle 404 in a vehicle convoy. In the example depicted in FIG. 4, the lead vehicle 402 and following vehicle 404 are examples of the vehicle 100 depicted in FIG. 1, with either having any number of the components of the vehicle 100 depicted in FIG. 1. As described above, the parking of the following vehicle 404 is managed by the lead vehicle 402.

At some point, the virtual connection between the lead vehicle 402 and the following vehicle 404 has been disengaged, allowing the lead vehicle 402 to enter an available parking space. Following disengagement, the following vehicle 404 is prepared for parking. In the example depicted in FIG. 4, there are three available parking spaces 406-1, 406-2, 406-3. However, not all available parking spaces 406-1, 406-2, 406-3 may be suitable for the following vehicle 404. As such, the following vehicle parking system 170 identifies a recommended parking space for the following vehicle 404.

As described above, such a selection may be based on sensor data 250 from the lead vehicle 402 and the following vehicle 404. As such, the parking module 230 may acquire 1) data from a lead vehicle environment sensor 122, which has a first field of view 410, and 2) data from a following vehicle environment sensor 122, which has a second field of view 412. As depicted in FIG. 4, the fields of view 410, 412 of the different vehicles may be different such that using sensor data 250 from both vehicles expands the field of view of the environment in which available parking spaces are located and/or provides greater accuracy in 1) the representation of the parking spaces and 2) the suitability analysis of the parking spaces. For example, the third parking space 406-3 may be within the field of view 410 of the lead vehicle 402. However, identifying characteristics of the third parking space 406-3 based on a single sensor output may produce inaccurate information. Accordingly, when combined with the sensor data from the following vehicle 404, the characteristic information (e.g., the clearance) of the third parking space 406-3 may be more accurate.

As described above, the identification of a parking space for the following vehicle 404 may be based on the load characteristic of the following vehicle 404. In the example depicted in FIG. 4, the following vehicle 404 includes passengers and no cargo rack. The parking module 230 may negatively weigh the first parking space 406-1 due to the reduced clearance adjacent to the side doors of the following vehicle 404 when parked. Moreover, the second parking space 406-2 may be negatively weighted as the following vehicle 404 would have to reverse to enter such. By comparison, due to the presence of passengers who are likely to exit the following vehicle 404 through side doors, the parking module 230 may select the third parking space 406-3 as the recommended parking space based on the side door clearance that the third parking space 406-3 provides as compared to the first parking space 406-1. In this example, the parking module 230 may also identify and present the trajectory 408 of the following vehicle 404 to enter the third parking space 406-3 on the HMI so that the lead driver may review, observe, and authorize the autonomous parking of the following vehicle based on the trajectory 408.

FIG. 5 illustrates an example of parking a following vehicle in a vehicle convoy. In this example, the first parking space 406-1 may be within the field of view 410 of the lead vehicle 402 but outside of, or partially obscured within, the field of view 412 of the following vehicle 404 such that the cooperation between the sensor data 250 of the two vehicles provides a more complete view of the environment than if the output of one vehicle were relied on.

As compared to the example depicted in FIG. 4, in FIG. 5 the following vehicle 404 includes a cargo rack installed on the rear of the following vehicle 404. As such, the third parking space 406-3 may be negatively weighted due to the small clearance adjacent to the rear portion of the following vehicle 404. Moreover, the second parking space 406-2 may be negatively weighted as the following vehicle 404 would have to reverse to enter such. By comparison, due to the presence of the cargo rack at the rear of the following vehicle 404, the parking module 230 may select the first parking space 406-1 as the recommended parking space for the following vehicle 404 based on the rearward clearance the first parking space 406-1 provides as compared to the third parking space 406-3. Moreover, due to the cargo rack on the rear of vehicle 404, the parking module 230 may recommend the following vehicle 404 pull forward into the first parking space 406-1 to provide adequate access to the cargo rack. In this example, the parking module 230 may also identify and present the trajectory 514 of the following vehicle 404 to enter the first parking space 406-1 on the HMI so that the lead driver may review, observe, and authorize the autonomous parking of the following vehicle based on the trajectory 514.

FIG. 6 illustrates a lead vehicle HMI 616 for parking a following vehicle 404 of a vehicle convoy. As described above, parking of the following vehicle 404 is controlled through the lead vehicle 402, specifically by a driver or passenger of the lead vehicle 402. Also as described above, the environment sensor output 620 from the following vehicle 404 may be displayed on the HMI 616 of the lead vehicle 402. In an example, the environment sensor output 620 of the following vehicle 404 may be displayed alongside the environment sensor output 618 of the lead vehicle 402, as depicted in FIG. 6. Specifically, FIG. 6 depicts an HMI 616 which displays the field of view 410 of the lead vehicle 402 and the field of view 412 of the following vehicle 404 from FIG. 4. In an example, overlaid on top of these environment sensor outputs 618, 620 is a virtual indication of a parking space selected for the following vehicle 404 and in some cases a projected trajectory of the following vehicle 404 to the parking space. Through the HMI 616, a user may select a particular parking space for the following vehicle 404. As such, the HMI 616 provides a view of a cooperatively sensed environment of the convoy such that the lead vehicle 402 driver is presented with a more comprehensive view of the environment.

In another example, rather than displaying the environment sensor output 618, 620 side-by-side, the HMI 616 may display a merged/stitched version of the output. For example, the processor 110, or another processor, can merge the views from the lead vehicle 402 and the following vehicle 404 to generate a single view of the environment.

In an example, the HMI 616 presents a three-dimensional (3D) representation of the environment of the convoy based on the following vehicle environment sensor output 618 and the lead vehicle environment sensor output 620. That is, rather than presenting images captured from cameras as depicted in FIG. 6, the following vehicle parking system 170 may generate a 3D virtual representation of the environment based on the sensor output.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 110. In one or more arrangements, the processor(s) 110 can be a primary/centralized processor of the vehicle 100 or may be representative of many distributed processing units. For instance, the processor(s) 110 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 100.

The vehicle 100 can include one or more data stores 115 for storing one or more types of data. The data store 115 can be comprised of volatile and/or non-volatile memory. Examples of memory that may form the data store 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 115 is a component of the processor(s) 110. In general, the data store 115 is operatively connected to the processor(s) 110 for use thereby. The term “operatively connected,” as used throughout this description, can include direct or indirect connections, including connections without direct physical contact.

In one or more arrangements, the one or more data stores 115 include various data elements to support functions of the vehicle 100, such as semi-autonomous and/or autonomous functions. Thus, the data store 115 may store map data 116 and/or sensor data 119. The map data 116 includes, in at least one approach, maps of one or more geographic areas. In some instances, the map data 116 can include information about roads (e.g., lane and/or road maps), traffic control devices, road markings, structures, features, and/or landmarks in the one or more geographic areas. The map data 116 may be characterized, in at least one approach, as a high-definition (HD) map that provides information for autonomous and/or semi-autonomous functions.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. In one or more arrangements, the map data 116 includes one or more static obstacle maps 118. The static obstacle map(s) 118 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 119 is data provided from one or more sensors of the sensor system 120. Thus, the sensor data 119 may include observations of a surrounding environment of the vehicle 100 and/or information about the vehicle 100 itself. In some instances, one or more data stores 115 located onboard the vehicle 100 store at least a portion of the map data 116 and/or the sensor data 119. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 120 and/or the one or more sensors can be operatively connected to the processor(s) 110, the data store(s) 115, and/or another element of the vehicle 100.

Various examples of different types of sensors will be described herein. However, it will be understood that the embodiments are not limited to the particular sensors described. In various configurations, the sensor system 120 includes one or more vehicle sensors 121 and/or one or more environment sensors. The vehicle sensor(s) 121 function to sense information about the vehicle 100 itself. In one or more arrangements, the vehicle sensor(s) 121 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 120 can include one or more environment sensors 122 that sense a surrounding environment (e.g., external) of the vehicle 100 and/or, in at least one arrangement, an environment of a passenger cabin of the vehicle 100. For example, the one or more environment sensors 122 sense objects the surrounding environment of the vehicle 100. Such obstacles may be stationary objects and/or dynamic objects. Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 includes one or more radar sensors 123, one or more LIDAR sensors 124, one or more sonar sensors 125 (e.g., ultrasonic sensors), and/or one or more cameras 126 (e.g., monocular, stereoscopic, RGB, infrared, etc.).

Continuing with the discussion of elements from FIG. 1, the vehicle 100 can include an input system 130. The input system 130 generally encompasses one or more devices that enable the acquisition of information by a machine from an outside source, such as an operator. The input system 130 can receive an input from a vehicle passenger (e.g., a driver/operator and/or a passenger). Additionally, in at least one configuration, the vehicle 100 includes an output system 135. The output system 135 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 140. Various examples of the one or more vehicle systems 140 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 141, a braking system 142, a steering system 143, a throttle system 144, a transmission system 145, a signaling system 146, and a navigation system 147.

The navigation system 147 can include one or more devices, applications, and/or combinations thereof to determine the geographic location of the vehicle 100 and/or to determine a travel route for the vehicle 100. The navigation system 147 can include one or more mapping applications to determine a travel route for the vehicle 100 according to, for example, the map data 116. The navigation system 147 may include or at least provide connection to a global positioning system, a local positioning system or a geolocation system.

In one or more configurations, the vehicle systems 140 function cooperatively with other components of the vehicle 100. For example, the processor(s) 110, the following vehicle parking system 170, and/or automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the navigation and/or maneuvering of the vehicle 100. The processor(s) 110, the following vehicle parking system 170, and/or the automated driving module(s) 160 may control some or all of these vehicle systems 140.

For example, when operating in the autonomous mode, the processor(s) 110, the following vehicle parking system 170, and/or the automated driving module(s) 160 may control the heading and speed of the vehicle 100. The processor(s) 110, the following vehicle parking system 170, and/or the automated driving module(s) 160 may cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 150 in at least one configuration. The actuators 150 are, for example, elements operable to move and/or control a mechanism, such as one or more of the vehicle systems 140 or components thereof responsive to electronic signals or other inputs from the processor(s) 110 and/or the automated driving module(s) 160. The one or more actuators 150 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 110, implement one or more of the various functions described herein. In various arrangements, one or more of the modules are a component of the processor(s) 110, or one or more of the modules are executed on and/or distributed among other processing systems to which the processor(s) 110 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 160. The automated driving module(s) 160, in at least one approach, receive data from the sensor system 120 and/or other systems associated with the vehicle 100. In one or more arrangements, the automated driving module(s) 160 use such data to perceive a surrounding environment of the vehicle. The automated driving module(s) 160 determine a position of the vehicle 100 in the surrounding environment and map aspects of the surrounding environment. For example, the automated driving module(s) 160 determines the location of obstacles or other environmental features including traffic signs, trees, shrubs, neighboring vehicles, pedestrians, etc.

The automated driving module(s) 160 either independently or in combination with the following vehicle parking system 170 can be configured to determine travel path(s), current autonomous driving maneuvers for the vehicle 100, future autonomous driving maneuvers and/or modifications to current autonomous driving maneuvers based on data acquired by the sensor system 120 and/or another source. In general, the automated driving module(s) 160 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
disengage a virtual connection between a lead vehicle and a following vehicle of a convoy based on a parking trigger for the convoy;
select a parking space for the following vehicle based on a load characteristic of the following vehicle; and
direct the following vehicle to the parking space.

2. The system of claim 1, wherein the machine-readable instructions further comprise an instruction that, when executed by the processor and upon disengagement of the virtual connection, causes the processor to present following vehicle environment sensor output on a human-machine interface (HMI) of the lead vehicle.

3. The system of claim 2, wherein the parking space is further selected based on the following vehicle environment sensor output and lead vehicle environment sensor output that cooperatively indicate a characteristic of the parking space.

4. The system of claim 3, wherein the machine-readable instructions further comprise an instruction that, when executed by the processor, causes the processor to display a three-dimensional (3D) representation of an environment of the convoy based on the following vehicle environment sensor output and the lead vehicle environment sensor output.

5. The system of claim 1, wherein the parking trigger is at least one of:
an indication that the lead vehicle is stationary;
an indication that the lead vehicle is in a parking space; or
an indication that the lead vehicle is in a parking lot.

6. The system of claim 1, wherein the machine-readable instructions further comprise an instruction that, when executed by the processor, causes the processor to identify and display a projected trajectory of the following vehicle to the parking space.

7. The system of claim 1, wherein:
the load characteristic comprises at least one of:
a type of a load of the vehicle; or
a region of the vehicle where the load is to be removed; and
the parking space is selected based on a clearance adjacent to the region of the vehicle where the load is to be removed.

8. The system of claim 7, wherein:
the load characteristic comprises a quantity of passengers within the vehicle and a position of the passengers within the vehicle; and
the parking space is selected based on the clearance adjacent to the region of the vehicle where the passengers are to exit.

9. The system of claim 7, wherein:
the load characteristic comprises an object to be unloaded from the following vehicle and a door through which the object is to be unloaded; and
the parking space is selected based on the clearance adjacent to the door through which the object is to be unloaded.

10. The system of claim 1, wherein the machine-readable instruction to identify a parking space for the following vehicle based on a load characteristic of the following vehicle further comprises an instruction that, when executed by the processor, causes the processor to identify the parking space based on a machine-learning analysis of a user history of unloading.

11. A non-transitory machine-readable medium comprising instructions that, when executed by a processor, cause the processor to:
disengage a virtual connection between a lead vehicle and a following vehicle of a convoy based on a parking trigger for the convoy;
select a parking space for the following vehicle based on a load characteristic of the following vehicle; and
direct the following vehicle to the parking space.

12. The non-transitory machine-readable medium of claim 11, wherein:
the instructions further comprise an instruction that, when executed by the processor and upon disengagement of the virtual connection, causes the processor to present following vehicle environment sensor output on a human-machine interface (HMI) of the lead vehicle; and
the parking space is further selected based on the following vehicle environment sensor output and lead vehicle environment sensor output that cooperatively indicate a characteristic of the parking space.

13. The non-transitory machine-readable medium of claim 11, wherein:
the load characteristic comprises at least one of:
a type of a load of the vehicle; or
a region of the vehicle where the load is to be removed; and
the parking space is selected based on a clearance adjacent to the region of the vehicle where the load is to be removed.

14. The non-transitory machine-readable medium of claim 13, wherein:
the load characteristic comprises a quantity of passengers within the vehicle and a position of the passengers within the vehicle; and
the parking space is selected based on the clearance adjacent to the region of the vehicle where the passengers are to exit.

15. The non-transitory machine-readable medium of claim 13, wherein:
the load characteristic comprises an object to be unloaded from the following vehicle and a door through which the object is to be unloaded; and
the parking space is selected based on the clearance adjacent to the door through which the object is to be unloaded.

16. The non-transitory machine-readable medium of claim 11, wherein an instruction to identify a parking space for the following vehicle further comprises an instruction that, when executed by the processor, causes the processor to identify the parking space based on a machine-learning analysis of a user history of unloading.

17. A method, comprising:
disengaging a virtual connection between a lead vehicle and a following vehicle of a convoy based on a parking trigger for the convoy;
selecting a parking space for the following vehicle based on a load characteristic of the following vehicle; and
directing the following vehicle to the parking space.

18. The method of claim 17:
further comprising, upon disengagement of the virtual connection, presenting following vehicle environment sensor output on a human-machine interface (HMI) of the lead vehicle; and
wherein selecting the parking space for the following vehicle is further based on the following vehicle environment sensor output and lead vehicle environment sensor output that cooperatively indicate a characteristic of the parking space.

19. The method of claim 17, wherein:
the load characteristic comprises at least one of:
a type of a load of the vehicle; or
a region of the vehicle where the load is to be removed; and
the parking space is selected based on a clearance adjacent to the region of the vehicle where the load is to be removed.

20. The method of claim 17, wherein identifying a parking space for the following vehicle further comprises identifying the parking space based on a machine-learning analysis of user history of unloading.
